(19) United States
(12) Patent Application Publication
(10) Pub. No.: US 2004/0172468 A1
(43) Pub. Date: Sep. 2, 2004

(54) Automatic web application access reproducer

(75) Inventors: Jian Cai, Sunnyvale, CA (US); Prasad Subramanian, Sunnyvale, CA (US)

Correspondence Address: David B. Ritchie, Thelen Reid & Priest LLP, P.O. Box 640640, San Jose, CA, 95164-0640, US

(73) Assignee: Sun Microsystems, Inc., a Delaware Corporation

(21) Appl. No.: 10/377,861

(22) Filed: Feb. 28, 2003

(51) Int. Cl. G06F 15/173

(52) U.S. Cl. 709/224; 709/203

(57) ABSTRACT

A method for automating web access captures web requests submitted by a user on a client to a web server. The web requests are filtered and stored on the web server. The filtered web requests are recorded in a log file on the web server. The log file is sent to the client. The client submits the filtered web requests from the log file to the web server. The web responses in response to the submitted filtered web requests are received and stored on the client as a reference file.

### FIELD OF THE INVENTION

The present invention relates to internet tools. More particularly, the present invention relates to a web application.

### BACKGROUND OF THE INVENTION

An increasing number of users access web applications. It is important to monitor, track, and record these web accesses so that further analysis actions can be performed. When a user manually clicks on links within the web pages in a random fashion on a client, it is difficult to record and reproduce detailed information about these web accesses. For instance, when engineers perform end-to-end testing on a web application, they have to click on links and record the URLs somewhere. The correct responses (e.g. HMTL pages) have to be saved manually from the web browsers to files. Unfortunately, when the web application is changed, the engineer has to go through this process again.

Although some web servers provide configurations allowing capturing and logging the user accesses, some limitations exist. First, the logging is used to store the user accesses for all applications deployed on the web server. It is therefore difficult to distinguish requests for a single application or for a group of applications. Second, the logged information contains basic information. For example, detailed information (e.g. header, request parameters, methods) associated with the requests cannot be retrieved. Third, no tools have been developed to parse/analyze the logged information.

An automated system for efficiently reproducing these web accesses would be desirable. Therefore, a need exists for a web application that automatically captures, tracks, and reproduces web accesses at an application level to ease the end-to-end testing of the web application.

### BRIEF DESCRIPTION OF THE INVENTION

A method for automating web access captures web requests submitted by a user on a client to a web server. The web requests are filtered and stored on the web server. The filtered web requests are recorded in a log file on the web server. The log file is sent to the client. The client submits the filtered web requests from the log file to the web server. The web responses in response to the submitted filtered web requests are received and stored on the client as a reference file.

### BRIEF DESCRIPTION OF THE DRAWINGS

The accompanying drawings, which are incorporated into and constitute a part of this specification, illustrate one or more embodiments of the present invention and, together with the detailed description, serve to explain the principles and implementations of the invention.

In the drawings:

FIG. 1 is a block diagram of a system for capturing, tracking, and reproducing web accesses in accordance with one embodiment of the present invention.

FIG. 2 is a flow diagram illustrating a method for capturing and storing web requests on a server side in accordance with one embodiment of the present invention.

FIG. 3A is a flow diagram illustrating a method for creating a log file of web requests from a client in accordance with one embodiment of the present invention.

FIG. 3B is a flow diagram illustrating a method for storing web responses from a web server in accordance with one embodiment of the present invention.

FIG. 4 is a block diagram illustrating an apparatus for capturing and storing web requests in accordance with one embodiment of the present invention.

FIG. 5 is a block diagram illustrating an apparatus for storing web responses in accordance with one embodiment of the present invention.

### DETAILED DESCRIPTION

Embodiments of the present invention are described herein in the context of a web automation application. Those of ordinary skill in the art will realize that the following detailed description of the present invention is illustrative only and is not intended to be in any way limiting. Other embodiments of the present invention will readily suggest themselves to such skilled persons having the benefit of this disclosure. Reference will now be made in detail to implementations of the present invention as illustrated in the accompanying drawings. The same reference indicators will be used throughout the drawings and the following detailed description to refer to the same or like parts.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with the present invention, the components, process steps, and/or data structures may be implemented using various types of operating systems, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

A system for capturing, tracking, and reproducing web accesses at the application level may include a web server and a web browser communicating with each other through a network. A user using a web browser submits web requests to the web server. The web requests are parsed with a filter storing the detailed information from the web requests in a storage file. The storage file is then sent to the web browser that submits web requests based on the content of the storage file. Web responses from the web requests based on the content of the storage file are stored in different files called “golden files”.

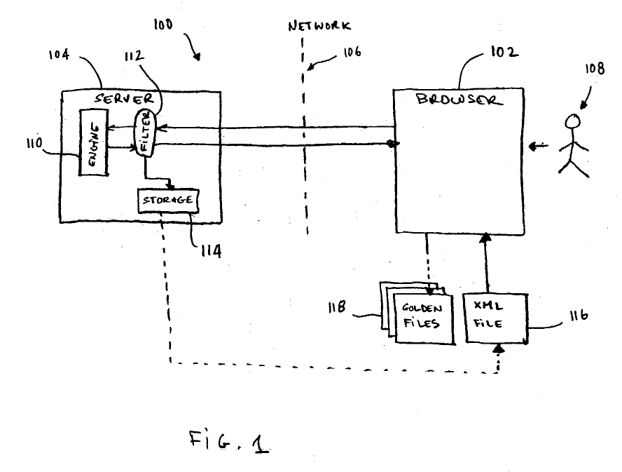

FIG. 1 is a block diagram of a system 100 for capturing, tracking, and reproducing web accesses in accordance with a specific embodiment of the present invention. A web browser 102 on a client communicates with a web server 104 through a network 106. One of ordinary skill in the art will recognize that the network may include a local area network (LAN), a wide area network (WAN), the Internet, and the like.

A user 108 interacts with the web browser 102 by clicking on links or entering information on the web browser 102. The web browser 102 may be any browser capable of displaying web pages and connecting to a network. The web browser generates a header and the body of the request and sends them to the web server 104. The web browser 102 is also capable of displaying responses in HTML format. FIG. 1 is for illustration purposes. One or more user may also be submitting web requests to the web server 104.

In accordance with one embodiment of the present invention, the web server 104 may include an engine 110, a set of filters 112, and a storage 114. The set of filters 112 receives web requests from the web browser 102. The set of filters 112 also filters the information from the web requests and stores the filtered information in storage 114. Each filter can be mapped to a web application. The set of filters 112 breaks down the web requests into several categories, for example, action, URL, and parameters. For illustration purpose, the filter 112 receives the web requests and changes the format of the information from the web requests based on attributes. In accordance with one embodiment of the present invention, the filtered information is saved into one XML file in the storage 114. The XML file contains some records of the request parameters sent from the web browser 102. In other words, the XML file may be seen a log file that gets the information from the web requests and organizes certain information in the XML file. The web requests submitted by the user 108 generates one XML file on the web server 104. The following illustrates a sample entry inside the XML file:

```
    <gtest request=“GET /tcatservlet-tests/StdPostest6 HTTP/1.0”
    debug=“0” host=“${host}” port=“${port}”
    goldenFile=“${wgdir}/stdPos/Resp6.html”
    testSession=“SessAttr”
    testCaseId=“StdPosTest6”
testCaseName=“StdPosTest6”
testCaseDescription=“getting context initialization parameters from
ServletContext”
    testStrategy=“”
    />
```

The engine 110 processes the web requests and submits web responses back to the web browser 102. The engine 110 may include any processing engine commonly known in the art, such as CGI, per, and the like. In accordance with one embodiment of the present invention, a Java web server may use Java Servlet and Java Server Pages technologies to dynamically generate responses based on client requests.

The recorded web requests stored in the XML file in the storage 114 are sent via the network 106 to the web browser 102. The web browser 102 reads the XML file 116 and submits web requests based on the XML file 116. The web responses received by the browser 102 as a result of the newly submitted web requests based on the XML file 116 are stored in several files 118 also known as “golden files”. These “golden files” 118 serve as key responses used in a web automation. The “golden files” 118 may, for example, be in HTML format. However, the above example is not limited to HTML format. Other formats may be used for the “golden files.” The JSP or Servlet designer validates all golden files to make sure they are the correct outputs. The golden files 118 will be used to compare with the response of the web server 104 in the later tests. When the web accesses are reproduced, the web responses received from the web server 104 are then compared with the “golden files” to determine whether the web server 104 has behaved correctly.

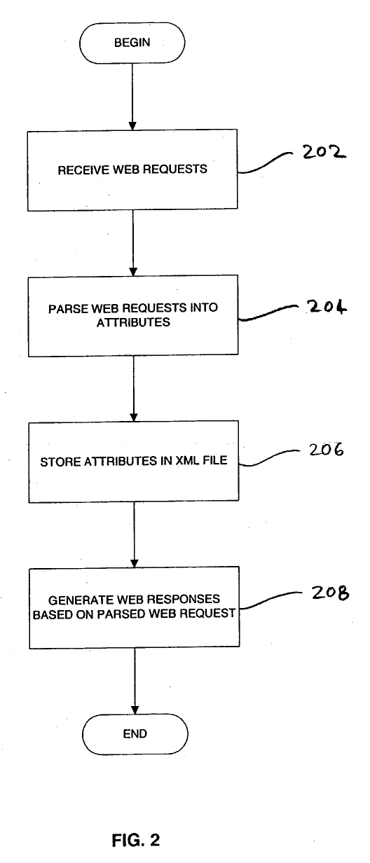

FIG. 2 is a flow diagram illustrating a method for capturing and storing web requests in accordance with one embodiment of the present invention. At 202, the web server 104 in FIG. 1 receives web requests (http requests) from user clicking links or applications on a web browser. The web requests may be received over a network as described above. At 204, the web server filters the web requests. For instance, the web server may parse (using HTTP standard protocol) the web requests into separate attributes. The attributes may be the method of the request (such as GET, POST, PUT, TRACK, and the like), the URL, the parameters, and the protocol version. For illustration purposes, an example of a web request may be as follows:

GET /tcatservlet-tests/StdPostest6?parameter=value HTTP/1.0

At 206, the attributes of the web requests are stored into a file. The file may be, for example, in an XML format. However, other format files may also be used. The XML file can be parsed by a special client called GTest to use Java class to access the web server based on the attributes.

At 208, the web server generates web responses based on the web requests. The web server provides a response for each of the request based on the URL and the parameters within the request. For each of the request, a servlet or a JSP may be used to generate a response.

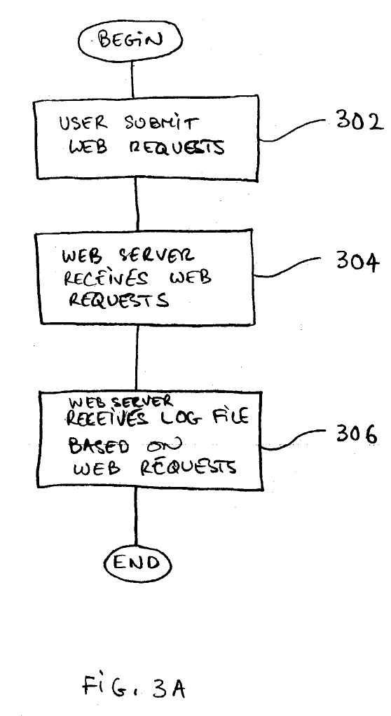

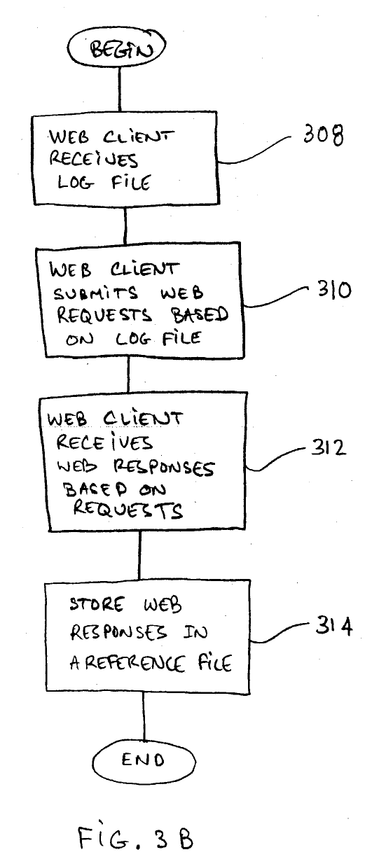

FIG. 3A is a flow diagram illustrating a method for creating a log file of web requests from a client in accordance with one embodiment of the present invention. At 302, a user submits web requests through a web browser to a web server. These HTTP requests may happen, for example, when a user enters information to be processed and clicks on a submission link. The web browser sends the web request to the web server at a certain HTTP port and gets a response back from the web server.

At 304, the web browser receives web responses from the web server in response the web requests of the user. At 306, the web browser also receives via HTTP, a log file containing the web requests submitted to the server. In accordance with one specific embodiment of the present invention, the file may be in XML format. The XML file contains the requested information for the browser to use to reproduce the web access patterns. The XML file is generated in the process described in FIG. 2.

FIG. 3B is a flow diagram illustrating a method for storing web responses from a web server in accordance with one embodiment of the present invention. At 308, the web browser receives the XML file (or log file) generated by the web server. At 310, the web browser submits web requests read from the XML file received at 308. At 312, the web client receives web responses in response to the recently submitted web requests. At 314, the web client stores the web responses on the client. The stored web responses are also known as the “golden files” and are used as a reference. Subsequent web responses may then be compared with the stored golden files.

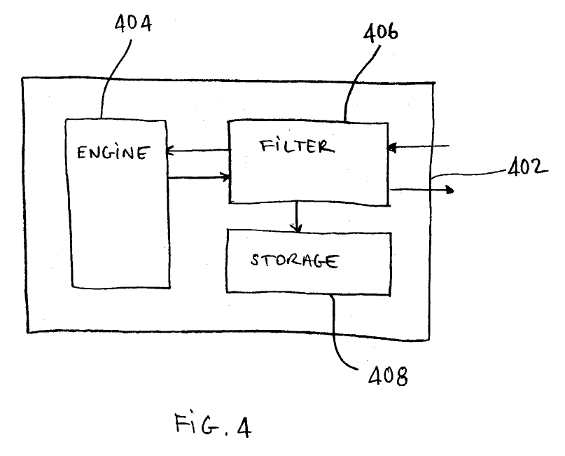

FIG. 4 is a block diagram illustrating an apparatus for capturing and storing web requests in accordance with one specific embodiment of the present invention. A web server 402 may include an engine 404, a filter 406, and a storage 408. Web requests received by the web server 402 are first received by the filter 406. The filter 406 filters the web requests. In particular, the filters parses the web requests into separate attributes and stores the filtered web requests in the storage 408. The storage 408 may include for example an XML file. The engine 404 receives the filtered web requests from filter 406, processes the filtered web requests, and generates web responses based the filtered web requests.

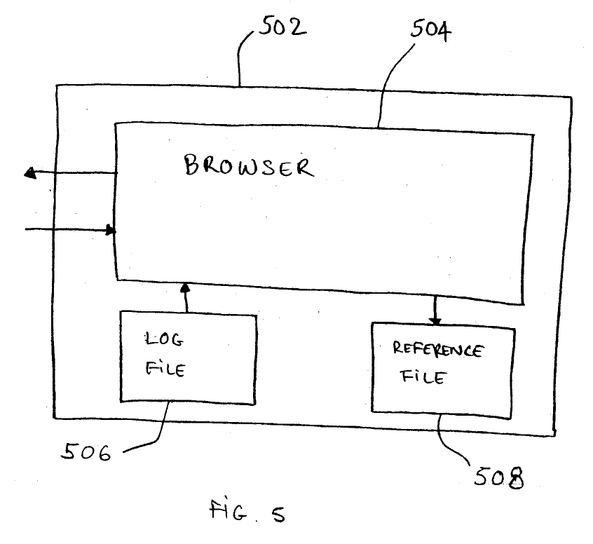

FIG. 5 is a block diagram illustrating an apparatus for storing web responses from a web server in accordance with one specific embodiment of the present invention. A client may include a browser 504, a log file 506, and a reference file 508. The browser 504 submits web requests and receives web responses. The log file 506 may contain the recorded attributes of web requests as described above. The log file may also be in an XML format. The browser 504 reads the log file 506 and submits web requests based on the log file 506. The web responses received by the browser 504 as a result of the newly submitted web requests based on the log file 506 are stored in several files in reference file 508. These files are also known as “golden files”. These golden files serve as key responses used in a web automation. The golden files may for example be in HTML format. The JSP or Servlet designer validates all golden files to make sure they are the correct outputs. The golden files will be used to compare with the response of the server in the later tests. When the web accesses are reproduced, the web responses received from the web server are compared with the golden files to determine whether the web server behaves correctly.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims.

What is claimed is:

1. A method for automating web access comprising:
parsing web requests from a user intro attributes; and
recording said attributes in a log file on a web server.

2. The method of claim 1 further comprising:
sending said log file to a client;
submitting other web requests based on said log file to said web server; and
receiving web responses on said client, said web responses in response to said submitted other web requests,
wherein said web responses are stored as a reference file.

3. A method for storing web requests from a client comprising:
receiving web requests;
filtering said web requests; and
storing said filtered web requests in a log file.

4. The method of claim 3 wherein said filtering further comprises parsing said web requests into attributes.

5. The method of claim 4 wherein said attributes include a header and a request parameter.

6. The method of claim 3 wherein said log file is in extensible markup language (XML) format.

7. The method of claim 3 further comprising:
sending said log file to the client.

8. A method for storing web responses from a web server comprising:
submitting web requests contained in a log file;
receiving web responses based on said web requests; and
storing said web responses in a reference file,
wherein said log file includes filtered web requests previously received by the web server,
wherein said reference file serves as a reference for web responses from the web server.

9. An web server comprising:
an engine;
a filter coupled to said engine; and
a file coupled to said filter,
wherein said filter parses web requests received by said engine; and
wherein said file stores said parsed web requests.

10. A client comprising:
a browser;
a first file coupled to said browser;
a second file coupled to said browser,
wherein said first file includes filtered web requests previously received by a web server,
wherein said second file includes web responses in response to said filtered web requests.

11. A program storage device readable by a machine, tangibly embodying a program of instructions readable by the machine to perform a method for automating web access, the method comprising:
filtering web requests from a user; and
recording said filtered web requests in a log file on a web server.

12. A program storage device readable by a machine, tangibly embodying a program of instructions readable by the machine to perform a method for storing web requests from a client, the method comprising:
receiving web requests;
filtering said web requests; and
storing said filtered web requests in a log file.

13. A program storage device readable by a machine, tangibly embodying a program of instructions readable by the machine to perform a method for storing web responses from a web server, the method comprising:
submitting web requests contained in a log file;
receiving web responses based on said web requests; and
storing said web responses in a reference file,
wherein said log file includes filtered web requests previously received by the web server,
wherein said reference file serves as a reference for web responses from the web server.

14. An apparatus for automating web access comprising:
means for filtering web requests from a user; and
means for recording said filtered web requests in a log file on a web server.

15. An apparatus for storing web requests from a client comprising:
means for receiving web requests;
means for filtering said web requests; and
means for storing said filtered web requests in a log file.

16. An apparatus for storing web responses from a web server comprising:
means for submitting web requests contained in a log file;
means for receiving web responses based on said web requests; and
means for storing said web responses in a reference file,
wherein said log file includes filtered web requests previously received by the web server,
wherein said reference file serves as a reference for web responses from the web server.
